(19) United States
(12) Patent Application Publication
(10) Pub. No.: US 2005/0152714 A1
(43) Pub. Date: Jul. 14, 2005

(54) Preventing printer toner leakage

(76) Inventor: Christopher Anthony Blake Lansdown, Ontario (CA)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/033,932

(22) Filed: Jan. 12, 2005

Related U.S. Application Data
(60) Provisional application No. 60/535,487, filed on Jan. 12, 2004.

(51) Int. Cl. G03G 15/00; G03G 15/08

(52) U.S. Cl. 399/103; 399/109

(57) ABSTRACT

A printer cartridge comprising a sealant to prevent toner leakage wherein the sealant comprises an oil and a thickener. The oil is a perhalogenated oil, a silicone oil or a synthetic hydrocarbon oil. The sealant is applied as a coating on at least one of the surface each end of a developer roller or the surface of each of a pair of end seals bearing against one end each of the developer roller. There is also disclosed a method to remanufacture printer cartridges with reduced toner leakage.

### CROSS-REFERENCE TO RELATED APPLICATION

This application claims priority to U.S. Provisional Application No. 60/535,487, filed on Jan. 12, 2004.

### FIELD OF THE INVENTION

The present invention generally relates to printer cartridges and more particularly to a new or remanufactured printer cartridge comprising a sealant to protect against toner leakage and to methods therefor.

### BACKGROUND OF THE INVENTION

Laser printers, photocopiers and facsimile (fax) machines are electrophotographic image-forming devices which apply an opaque coating, commonly referred to as toner, to selected areas of a substrate, such as a sheet of paper, in order to produce an image on the substrate. The toner is transferred to selected areas through triboelectric charges. The toner is a fine powder that must be applied in a controlled manner to produce imprints of the required quality. It has therefore become conventional to provide supplies of the toner in a printer cartridge assembly. As used herein, “printer cartridge” is synonymous with “printer cartridge assembly”, “toner cartridge”, and “cartridge”.

A large number of printer cartridges are based on developer rollers. In these printer cartridges, a developer roller is supplied with a coating layer thickness of toner from a supply, which may be a hopper, other storage vessel, optionally through a supply roller, in contact with the developer roller. A doctor bar regulates the thickness of toner on the developer roller. The developer roller transfers its toner coating to a photoreceptor, e.g., a charged drum. Toner particles adhere to regions of the charged drum based on an image projected onto the drum so that a visible toner image is produced on the drum. Electric potential differences between the drum and a transfer roller draws the toner from the drum onto a substrate that is disposed between the drum and transfer roller. Such printer cartridges include those manufactured by Canon, Inc., Tokyo, Japan, Hewlett-Packard Company, Palo Alto, Calif., Lexmark International, Inc., Lexington, Ky., Brother Kogyo Kabushiki Kaisha, Nagoya, Japan, Samsung Electronics Co., Ltd., Suwon-Si, South Korea, Xerox Corporation, Rochester, N.Y., among others.

In such printer cartridges, toner that has been deposited on the developer roller has a tendency to migrate in an axial direction along the developer roller, gradually passing between the ends of the developer roller and seals, that is, leaking, such as, onto gear mechanisms for rotating the developer roller, and then into the image-forming device. For example, leaks may occur around the ends of the developer roller. Toner leaks cause a myriad of problems. First, productivity of the toner cartridge is reduced because fewer pages are printed from a cartridge that leaks toner than a cartridge that does not. Leaking toner contaminates the inside of the image-forming device, resulting in poor print quality, such as smudge marks on the printed substrate, and may permanently damage the device. In addition, toner may be transferred to a user's hands or clothing when performing maintenance on the device, such as replacing a spent cartridge.

Previous attempts to prevent toner leakage have involved use of seals placed at the axial ends of the developer roller. Seal materials that have been used include those comprising foams, sponges, felts, etc., comprising polymeric materials, such as polyurethanes and polytetrafluoroethylene. Despite use of seals, gaps may still exist. Even if gaps are removed, over a period of use, a seal may become abraded or deformed, resulting in formation of a new gap through which toner can leak. Still further, seals may also become saturated with toner and no longer be capable of preventing toner leakage.

Printer cartridges generally include not only a supply source such as a hopper for the toner, but also part of a dispensing mechanism for transferring the toner onto a sheet, and, therefore, are relatively expensive to manufacture. For this reason, it is desirable to reuse printer cartridges by “remanufacturing” the cartridge, which may involve replenishing the toner and reconditioning the dispensing mechanism, including replacing worn or damage parts, as necessary. Printer cartridges may then be used over a number of cycles to reduce the cost associated with use of printer cartridges and avoid waste.

It is desirable for a remanufactured printer cartridge to perform at the same level as a new printer cartridge and, therefore, a number of techniques have been developed to ensure proper performance. However, despite the care and attention normally utilized in remanufacturing printer cartridges, some problems persist and limit the performance of remanufactured cartridges. Remanufactured cartridges are particularly prone to leak toner past the seals provided to restrain leaking. Leaking toner may migrate within the image-forming device (e.g., printer or copier) and produce unsatisfactory performance, both in the print quality and lifetime of the device. Rubber developer roller-based cartridges have been found to exhibit this trait, such as those cartridges utilized in the Lexmark T620 printer.

It is therefore an objective of the present invention to obviate or mitigate the above disadvantages.

### SUMMARY OF THE INVENTION

The present invention provides a solution to defective, leaking printer cartridges. The present invention provides a printer cartridge which does not leak toner, thereby protecting the internal parts of an electrophotographic image-forming device from potential damage caused by toner leaks inside the device. The present invention further provides a method for preventing toner leakage comprising applying a sealant. The present invention further a method to remanufacture a printer cartridge, thus improving printer cartridge economics by remanufacturing a toner cartridge that has been taken out of operation.

More specifically, the present invention provides a printer cartridge comprising a sealant to prevent toner leakage wherein the sealant comprises a perhalogenated oil and a thickener and the sealant is present as a coating on at least one of (a) the surface of each end of a developer roller or (b) the surface of each of a pair of end seals wherein each end seal bears against one end of a developer roller. Preferably, the sealant is present as a coating on both (a) the surface of each end of the developer roller and (b) the surface of each end seal. In an alternative printer cartridge of this invention, the sealant comprises a silicone oil and a thickener. In still another alternative printer cartridge of this invention, the sealant comprises a synthetic hydrocarbon oil and a thickener.

The present invention further provides a method to prevent toner leakage comprising applying a sealant to at least one of (a) the surface of each end of a developer roller or (b) the surface of each of a pair of end seals wherein each end seal bears against one end of a developer roller and wherein the sealant comprises an oil and a thickener wherein the oil is selected from the group consisting of a perhalogenated oil, a silicone oil and a synthetic hydrocarbon oil. Preferably, the method comprises applying sealant to both the surface of each end of the developer roller and the surface of each end seal.

Still further, the present invention provides a method to remanufacture a toner cartridge comprising (a) filling a toner supply with toner; and (b) applying a sealant to at least one of (1) the surface of each end of a developer roller or (2) the surface of each of a pair of end seals wherein each end seal bears against one end of a developer roller, and wherein the sealant comprises an oil and a thickener wherein the oil is selected from the group consisting of a perhalogenated oil, a silicone oil and a synthetic hydrocarbon oil. Preferably, both the surface of the ends of the developer roller and the surface of the end seals are coated with sealant.

### DETAILED DESCRIPTION OF THE INVENTION

In general terms, the present invention provides a printer cartridge comprising a sealant to prevent toner leakage, a method to prevent toner leakage by applying a sealant and a method of remanufacturing a printer cartridge.

Printer Cartridge

A printer cartridge for use in this invention comprises a developer roller and a pair of end seals wherein each end seal bears against one end of the developer roller. The printer cartridge also typically comprises a doctor bar, and a developer roller sealing blade. The end seals may also bear against the doctor bar and the developer roller sealing blade. When the developer roller, doctor bar and sealing blade are all present in the cartridge of this invention, they are positioned parallel to each other, having their ends connected through the end seals. Such printer cartridges are known in the art and despite the presence of the end seals, toner has been found to leak from such cartridges.

The printer cartridge of this invention further comprises a sealant, present as a coating, on at least one of the surface of each end of the developer roller and the surface of each end seal. Preferably the sealant is present as a coating on both the surface of each end of the developer roller and the surface of the end seals. Surprisingly, the printer cartridge of this invention has been found to have greatly reduced toner leakage, such that the cartridge can be used and remanufactured several times without visible toner leakage occurring.

Many styles of printer cartridges can be modified to provide the printer cartridge of this invention by application of the sealant described hereinbelow. In general, the printer cartridge of this invention may further comprise a housing which comprises a toner supply and a developer roller mounted on the housing, with attached components for transfer of toner to a substrate. The toner supply is typically a hopper or other toner storage vessel. The toner supply is in contact with the developer roller and supplies the developer roller with toner, optionally through a supply roller or adder roller.

The developer roller itself comprises an annular body. The developer roller is mounted to a shaft, which extends through and beyond the annular body and fits into the gears or turning mechanism for developer roller operation. In one embodiment, a coating of sealant is present at each end of the annular body of the developer roller. Preferably, the coating of sealant does not extend beyond the width of the end seal from the outer edge of the developer roller surface. During operation of an image-forming device, the developer roller becomes coated with a coating layer of toner from the toner supply. The coating of sealant preferably does not contact the layer of toner during operation. If sealant extends too far on the developer roller, toner will not adhere to the roller surface. An incomplete or imperfect image on the substrate may result. However, cleaning the developer roller of sealant in the area where toner comes into contact with the roller should restore image quality.

The doctor bar is typically a thin strip construction in contact with the toner layer on the developer roller. The doctor bar meters out an even layer of toner on the developer roller, for example, through a spring mechanism. The doctor bar is disposed at an angle with respect to the developer roller to assist with maintaining a uniform thickness of toner layer on the developer roller.

The developer roller sealing blade is a typically a thin polymer layer with an edge to prevent toner leakage from the toner supply around the developer roller into the image-forming device. The sealing blade is disposed at an angle with respect to the developer roller. More than one sealing blade may be present. The sealing blade often comprises a thin layer of polyester or polyurethane. It should be recognized that the presence of a sealing blade does not prevent all toner leakage.

An end seal bears against each end of the developer roller and in certain styles and models of printer cartridges also against the ends of the doctor bar and developer roller sealing blade. These seals are generally semicircular in shape. In some printer cartridges, the end seals may be referred to as “J” seals. The surface of each end seal is typically fully coated even though portions of the surface are not in contact with the developer roller, doctor bar and sealing blades.

In one embodiment, the region of the developer roller in contact with each end seal is coated with sealant. In a second embodiment, the surface of each of the end seals in contact with the developer roller is coated with sealant. In a preferred third embodiment, both the surfaces of each end of the developer roller and the surfaces of the end seals are coated with sealant.

Each end seal is attached to the printer cartridge housing for example, through a flange or end plate, which may extend from the toner supply. The end seal may be constructed of foam, felt, rubber. Specific materials which can be used include silicone rubber, polymers, such as polyurethane, polyester and fluorinated polymers such as polytetrafluoroethylene.

Application of Sealant

Toner leakage is prevented by effectively applying a coating of sealant to at least one of the developer roller ends or the end seals to prevent toner leaks in a printer cartridge. Preferably both the developer roller ends and the surfaces of the end seals are coated with sealant.

In one embodiment, sealant is applied to each end of the developer roller. The sealant coating extends from the edge of the developer roller surface to the width of the end seal. The width of the end seal varies depending on the cartridge manufacturer and model. For a Lexmark T620 printer cartridge the desired width of the sealant coating on the developer roller is about 3 mm wide.

In a second embodiment, sealant is applied to the surface of each end seal. In a third, preferred embodiment, sealant is applied to the surfaces of both the ends of the developer roller and the end seals.

Preferably, prior to applying sealant, each surface to which sealant is to be applied is cleaned and dried. Any means can be used that is known to create a clean surface, such as by wiping, wiping with a solvent, such as an alcohol, such as isopropanol, or using a source of compressed air.

Sealant is applied to the developer roller and/or end seals in an effective amount. By “an effective amount” it is meant that the sealant is added to form at least a continuous layer around the circumference of the developer roller and/or at least a layer on the surface of the end seals. Determination of an effective amount is conveniently performed by visual inspection. Quantitatively, an effective amount will vary depending on the cartridge. If excess sealant has been added, it should be removed, for example, wiped off, before the cartridge is placed in operation.

To provide a coating around the circumference of the developer roller, one specific method comprises applying a small bead to each end of the developer roller surface using any convenient method, such as by using a cotton swab. This method preferably further comprises rotating the developer roller to expose a new surface of the developer roller end. Rotating may be effective to distribute the sealant around the roller body. This method further comprises visually inspecting the new surface, and repeating the steps of applying sealant, rotating the developer roller and inspecting the new surface until the ends of the developer roller are coated with a continuous layer of sealant.

Once the developer roller has been effectively coated, it has further been found to be advantageous to apply an additional amount of sealant to the surface of the developer roller until a reservoir of sealant is in contact with the surface of a developer roller sealing blade in the area where the sealing blade overlaps the end seal. The sealant should still have a width of the end seal. It is believed that the reservoir of sealant serves to replenish the coating of sealant on the developer roller as it is rotated by the drive gear during operation of the printer cartridge to refill the contact surfaces on the developer roller and the end seals during operation as the initial charge may wear off.

Sealant

The sealant useful in the present invention provides a coating that is nonconductive, nonmigrating and does not bond to carbon products, such as toner. The sealant comprises an oil and a thickener. The oil is selected from the group consisting of a perhalogenated oil, a silicone oil and a synthetic hydrocarbon oil. In one embodiment of this invention the sealant comprises a perhalogenated oil and a thickener. In a second embodiment of this invention the sealant comprises a silicone oil and a thickener. In a third embodiment of this invention the sealant comprises a synthetic hydrocarbon oil and a thickener.

The sealant preferably comprises a perhalogenated oil and a thickener. An example of such a commercially available sealant is “CHARGE BLOCKER”, produced by E. I. du Pont de Nemours and Company, Wilmington, Del.

A perhalogenated oil includes perfluoropolyether or perfluoroalkyl ether, a polytrifluorochloroethylene, and derivatized perfluoropolyethers, such as fluoroether triazines, and mixtures thereof. More preferably, the perhalogenated oil is a perfluoropolyether.

Perfluoropolyether is synonymous with perfluoropolyalkylether and perfluoroalkyl ether. Other synonymous terms frequently used include “PFPE”, “PFPE oil”, “PFPE fluid”, and “PFPAE”.

The perhalogenated oil may be a polytrifluorochloroethylene. Polytrifluorochloroethylenes suitable for use in the invention can have the formula of (—CCl₂CFCl—)₂ where s is 2-100, inclusive. Example of suitable polytrifluorochloroethylenes are HALOCARBON oils from Halocarbon, Riveredge, N.J. The preferred polytrifluorochloroethylene is HALOCARBON 200.

Silicone oils suitable for use in the invention can be any silicone oil, including fluorosilicone oils. A preferred fluorosilicone oil is a fluorosilane, a fluorosiloxane, or combinations thereof. A suitable fluorosilicone can have the formula of R_{f}—(CH₂)ₙ—Si—R²₃ in which R_{f} is CF₂CF₃, a C₃ to C₆ perfluoroalkyl group, or combinations thereof and n can be 1 to 100, and each R² can be independently an alkyl group, an alkoxy group, a thioalkyl group, an amino group, an aryl group, or combinations of two or more thereof. An example of suitable fluorosilicone is DOW CORNING FS-1265 fluorosilicone oil from Dow Corning, Midland, Mich.

Synthetic hydrocarbon oils are known and their description is omitted for brevity.

The sealant of this invention further comprises a thickening agent. The thickening agent may be an inorganic or an organic thickening agent. Combinations of two or more thickening agents may also be used. Suitable inorganic thickening agents are selected from the group consisting of talc, silica, clay, boron nitride, titanium dioxide, and mixtures thereof. Suitable organic thickening agents are selected from the group consisting of polydimethylsiloxane, polyurea, polyurethane, metal soaps, and halogenated organic thickening agents. Preferred halogenated thickening agents are polytetrafluoroethylene (“PTFE”), polychlorotrifluoroethylene (“CTFE”). For metal soaps, the metal is preferably selected from the group consisting of lithium, sodium, calcium, aluminum, and mixtures thereof. Especially preferred is an organic thickening agent, more preferably a halogenated thickening agent, most preferably, polytetrafluoroethylene.

The sealant useful in this invention may further comprise one or more additives, for example, to enhance physical properties and/or to improve performance in use. Additives are typically present in minor amounts. Such additives may be for example, perfluoroalkyl surfactants or polyoxyperfluoroalkyl surfactants. The sealant may comprise other additives known in the art such as a stabilizer, anticorrosive agent, colorant, anti-oxidant, viscosity modifier, reinforcing filler, or anti-wear agent and mixtures of two or more thereof.

Remanufacturing a Printer Cartridge

Remanufacturing is a process by which a used toner cartridge, especially a toner cartridge with depleted or low toner, is converted to a usable toner cartridge. At a minimum, a remanufacturing process comprises adding a new charge of toner to a toner supply, such as a hopper. A quality remanufacturer also inspects key parts, such as the developer roller, the doctor bar, sealing blades, and the photoreceptor, replacing them if necessary.

The present invention provides a method to enable manufacturers and remanufacturers to save significant costs by eliminating production and distribution of leaking, defective printer cartridges. The present invention further increases productivity of individual printer cartridge by facilitating reuse of cartridges. Reuse of cartridges saves on valuable landfill space and is thus environmentally friendly. The present invention also prevents costly damage to electrophotographic imaging devices caused by leaking toner cartridges.

The present invention provides a method to remanufacture a printer cartridge comprising filling a toner supply with toner and applying a sealant wherein the sealant comprises an oil and a thickener. The oil is selected from the group consisting of a perhalogenated oil, a silicone oil and a synthetic hydrocarbon oil. Optionally, prior to filling the toner supply, the method further comprises discarding any toner remaining in the toner supply from the previous printer cartridge use. Preferably, the sealant comprises a perhalogenated oil and a thickener.

One particular embodiment of a method to remanufacture a printer cartridge comprises or consists essentially of filling a toner supply with toner and applying a sealant to the ends of a developer roller. Printer cartridges as described above can be remanufactured according to this method. Particular methods of applying the sealant are as described hereinabove. These steps generally can be performed in either order. However, the toner supply should be filled before applying the sealant if the toner supply is depleted.

In a second embodiment of a method to remanufacturing a printer cartridge, the method comprises disassembling the printer cartridge to expose a pair of end seals wherein, in an assembled printer cartridge, each end seal bears against one end of a developer roller; cleaning the end seals; applying sealant to the end seals; reassembling the printer cartridge; and, filling a toner supply with toner. It should be recognized in this embodiment that toner supply should not be filled prior to reassembling the printer cartridge. Optionally, in this embodiment, after reassembling the printer cartridge, and preferably, after filling the toner supply, the method further comprises applying a sealant to the ends of a developer roller.

In the second embodiment, preferably, the method further comprises inspecting the printer cartridge and its components for sign of wear or damage. Components include developer roller, doctor bar, drum, wiper blade, etc., where specific parts will depend on the individual cartridge and its design. Components of printer cartridges are generally known and will be apparent upon disassembling the cartridge to those skilled in the art. Inspecting is typically performed visually. Disassembling and inspecting may involve removing the developer roller, doctor bar and other components from the printer cartridge. If no wear or damage is observed, components that were removed may be cleaned and re-installed as the printer cartridge is reassembled.

Cleaning of components in the present may comprise, any known methods of clean, with or without a solvent, such as an alcohol, like isopropanol, or by using other media compressed air. Previously used components that will be reused are preferably thoroughly cleaned, dried and inspected before re-installing in the printer cartridge.

### General Description of Tests

Tests were conducted with a Lexmark T620 cartridge, available from Lexmark International, Inc., Lexington, Ky. This toner cartridge has a hopper and a dispensing assembly. The hopper has a generally cylindrical outer wall that extends to an outlet chute defined by a pair of walls, which may be referred as a toner hopper end plate assembly. A paddle is rotatably mounted within the housing to agitate toner within the housing and deliver it to chute.

Toner within the chute is dispensed in a controlled manner by the dispensing mechanism that includes an adder roller rotatably supported between the walls of the chute. Toner is applied to the developer roller by the adder roller. A doctor blade removes surplus toner from the surface of the developer roller. The developer roller has an annular body that is mounted to a shaft. The shaft projects axially beyond the body at both ends and is received in a bearing, which is fixed in a wall of the toner hopper end plate assembly and a drive gear on the outside of this end plate is attached to a protruding axle of the developer roller. On the opposite end is a removable bearing that also has an electrical contact for the developer roller. The developer roller is rotatably supported by the two bearings at either end. A Teflon® washer is interposed between each end of the annular body of the developer roller and the bearings.

A pair of sealing blades, inner and outer sealing blades are present. The inner sealing blade bears against a lower portion of the developer roller body to inhibit the egress of toner from the chute. A doctor bar is biased into engagement with the upper surface of developer roller body by a leaf spring so that the developer roller delivers a uniform level of toner.

At each wall of the end plate assembly, a flange is formed with a channel having a linear portion and a part cylindrical recess. Each marginal end of the developer roller body is located in the cylindrical recess and the doctor bar is supported in the linear portion of the channel that permits limited radial movement relative to the developer roller.

An end seal, also known as a “J” seal, extends along one side of the linear portion of channel and around the circular recess that accommodates each marginal end of the roller body. The end seal is a resilient elastomeric compound whose purpose is to inhibit the flow of toner axially beyond the roller and past the flange. The inner sealing blade lays above the end seal. The inner sealing blade prevents toner from slipping underneath the developer roller from end to end.

The end seal has an outwardly directed surface that bears against the overlying portions of the doctor bar and developer roller body. Sealant is applied to the surface of the end seals and developer roller body. Sealant was found to be effective to inhibit leakage of the toner beyond the flanges.

It should be recognized that in the Tests of the Example, components including developer roller, doctor bars, wiper blades, et al., may be replaced by to illustrate the utility of components from different suppliers. After each test, the cartridge was inspected and no noticeable leakage of toner was observed.

In order to remanufacture the printer cartridge after the toner was depleted in the Tests below, the doctor bar tension spring was removed. Developer roller drive gear was removed. The electrical contact bearing was then removed. The developer roller was then removed by axially shifting and tilting the roller to disengage the shaft from the bearing. The doctor bar was then removed. The seals were cleaned with isopropanol to remove any surface contamination. The sealant was CHARGE BLOCKER, available from E. I. duPont de Nemours and Company, Wilmington, Del. Sealant was applied to each end seal to visibly coat. The cartridge was reassembled by installing the components in reverse order, replacing components as described below.

The hopper was filled with a fresh charge of toner.

For each test, CHARGE BLOCKER sealant was applied at each end of the developer roller. The developer roller was rotated manually in place to expose new surface for applying sealant. Sealant continued to be applied to the exposed surface of the developer roller and the roller was rotated, until, by visual inspection, a continuous band of sealant had been applied on the surface of the roller. The width of the end seal and coating on the developer roller was 3 mm. Additional sealant was applied to the surface of the developer roller until a reservoir of sealant remained on the surface of the developer roller sealing blade in the area where the sealing blade overlapped the end seal.

An original cartridge was used to begin the test series. Test pages were printed until the toner was exhausted. The cartridge was then disassembled and remanufactured as described above. Components were generally replaced as a matter of routine to test capability of components from different suppliers. The cartridge was typically run until the toner was low or depleted. Each time the cartridge was remanufactured, the number of pages was monitored and the following results obtained.

### EXAMPLE 1

Test 1. A Lexmark original cartridge for use with a Lexmark T620 printer was tested for performance. A new cartridge was used to run a test “E” page, with 5% of the test page covered. The print sequence for all tests involved the following steps. A thousand “E” pages were printed in sequence, double sided. A “Demo Page” and then the “Utilities Page” for the printer were then run. The Demo Page was run to determine the print quality and the Utilities Page was run to report the number of pages printed and the level of toner left in the cartridge. The original cartridge was used to print 33,000 pages at which time the cartridge ran out of toner.

Test 2. The cartridge from Test 1 was remanufactured. The developer roller, doctor bar, drum and wiper blade were removed from the cartridge. A new developer roller, available from Oasis Imaging Products, Inc., Nashua, N.H. was installed. A new doctor bar, wiper blade and AEG drum, each from Future Graphics, LLC, Los Angeles, Calif. were installed. A new Toner supply was refilled with 820 grams of toner from Oasis Imaging Products, Inc. A sealant, CHARGE BLOCKER, available from E. I. duPont de Nemours and Company, Wilmington, Del., was applied to each end of the developer roller and to each face of the seal.

The print sequence as described in Test 1 was repeated. The cartridge was used to print about 24,500 pages, at which time the test was ended due to low toner.

Test 3. The cartridge from Test 2 was remanufactured in the same manner as described under Test 2. With the following differences. The toner supply was refilled with 850 grams of toner from Future Graphics. It should be noted that fresh sealant, CHARGEBLOCKER, was applied as in Test 2. The print sequence as described in Test 1 was repeated. The cartridge was used to print about 3000 pages, at which time the test was ended due to poor print quality. Upon inspection, it was found that the developer roller showed signs of wear. However, no leakage of toner was observed.

Test 4. The cartridge from Test 3 was remanufactured generally as described under Test 2. However, the developer roller used in Test 3 was replaced with the developer roller used in Test 1. The toner supply was refilled with 795 grams of toner from Future Graphics. It should be noted that fresh sealant, CHARGEBLOCKER, was applied as in Test 2. The print sequence as described in Test 1 was repeated. The cartridge was used to print about 42,000 pages, at which time the test was ended due to drum failure. There remained 150 grams of toner in the supply.

No toner leakage occurred even though 9,000 more pages were printed than in Test 1 with the original printer cartridge. Thus, there was an increased efficiency and productivity of the toner cartridge when sealant was used.

No leaking of toner was observed during any of the Tests 1-4 and approximately 100,000 pages were printed using the original cartridge.

Test 5. The cartridge from Test 4 was remanufactured generally as described under Test 2. In this test, the cartridge was filled with 700 grams of Densigraphix toner, Densigraphix Kopi Inc., St. Bruno, Quebec. It should be noted that fresh sealant, CHARGEBLOCKER, was applied as in Test 2. A total of 33,670 pages were printed. The test was ended due to a low toner signal. No toner leaking was observed.

Test 6. The cartridge from Test 5 was remanufactured generally as described under Test 2. In this test, the cartridge was filled with 685 grams of toner from Static Control Components, Sanford, N.C. The drum was replaced with an Oddessy drum also from Static Control Components and a new doctor bar from Future Graphics, LLC was installed. A new wiper blade from Densigraphix Kopi Inc. was installed. It should be noted that fresh sealant, CHARGEBLOCKER, was applied as in Test 2. The developer roller remained the original developer roller, now on its fourth cycle, however, reconditioned by Print Infinity, Mississauga, Ontario.

Unlike the first five tests in which an “E” test page was printed, the printer was connected to a business staff and the print cartridge was used for printing under normal office conditions, including business letters, office forms, invoices, company checks and manuals. The cartridge lasted for a period of four months and was used to print 29,611 pages at which time; printing was halted due to a low toner signal. No leaking of toner was observed.

No toner leakage was observed from the toner supply, developer roller, or end seals during any of the series of Tests performed. The toner cartridge was used to print over 165,000 pages.

### EXAMPLE 2

A Xerox P8e printer cartridge, available from Fuji-Xerox Ltd., Tokyo, Japan, was observed to be leaking toner. The cartridge was removed from operation and disassembled from the drum side, leaving the developer roller in place. The cartridge was cleaned by wiping to remove toner from surfaces. The ends of the developer roller were also cleaned at the ends to remove toner. CHARGEBLOCKER was applied as a sealant to the ends of the developer rollers by applying a bead and rotating the roller in place repeatedly until the ends of the roller were coated with the sealant. The printer cartridge was returned to operation with no toner leakage observed.

### EXAMPLE 3

Example 2 was repeated with a Samsung ML 1210 printer cartridge, available from Samsung Electronics Co., Ltd., Suwon-Si, South Korea, that had been leaking toner during operation. After applying CHARGEBLOCKER sealant as described in Example 2, the printer cartridge was returned to operation with no toner leakage observed.

Although the invention has been described with references to certain specific embodiments, various modifications thereof will be apparent to those skilled in the art without departing from the spirit and scope of the invention.

1. A printer cartridge comprising a sealant to prevent toner leakage wherein the sealant comprises a perhalogenated oil and a thickener and the sealant is present as a coating on at least one of (a) the surface of each end of a developer roller or (b) the surface of each of a pair of end seals wherein each end seal bears against one of a developer roller.

2. The printer cartridge of claim 1 wherein the sealant is present as a coating on both (a) the surface of each end of the developer roller and (b) the surface of each end seal.

3. The printer cartridge of claim 2 wherein the perhalogenated oil is a perfluoropolyether.

4. The printer cartridge of claim 2 wherein the thickening agent is an inorganic thickening agent.

5. The printer cartridge of claim 4 wherein the thickening agent is selected from the group consisting of talc, silica, clay, boron nitride, titanium dioxide, and mixtures thereof.

6. The printer cartridge of claim 2 wherein the thickening agent is an organic thickening agent.

7. The printer cartridge of claim 6 wherein the thickening agent is selected from the group consisting of polydimethylsiloxane, polyurea, polyurethane, metal soaps, and halogenated organic thickening agents.

8. The printer cartridge of claim 7 wherein the thickening agent is a halogenated organic thickening agent.

9. The printer cartridge of claim 8 wherein the thickening agent is polytetrafluoroethylene.

10. The printer cartridge of 7 wherein the thickening agent is a metal soap.

11. The printer cartridge of claim 10 wherein the metal is selected from the group consisting of lithium, sodium, calcium, aluminum, and mixtures thereof.

12. The printer cartridge of claim 3 wherein the thickening agent is an inorganic thickening agent.

13. The printer cartridge of claim 3 wherein the thickening agent is an organic thickening agent.

14. The printer cartridge of claim 13 wherein the thickening agent is halogenated organic thickening agent.

15. The printer cartridge of claim 14 wherein the thickening agent is polytetrafluoroethylene.

16. The printer cartridge of claim 2 or 3 wherein the sealant further comprises one or more additives.

17. The printer cartridge of claim 16 wherein the additive is a stabilizer, anticorrosive agent, colorant, anti-oxidant, viscosity modifier, reinforcing filler or anti-wear agent and mixtures of two or more thereof.

18. A printer cartridge comprising a sealant to prevent toner leakage wherein the sealant comprises a silicone oil and a thickener and the sealant is present as a coating on at least one of (a) the surface of each end of a developer roller or (b) the surface of each of a pair of end seals wherein each end seal bears against one end of a developer roller.

19. The printer cartridge of claim 18 wherein the sealant is present as a coating on both (a) the surface of each end of the developer roller and (b) the surface of each end seal.

20. The printer cartridge of claim 19 wherein the thickening agent is an inorganic thickening agent.

21. The printer cartridge of claim 19 wherein the thickening agent is an organic thickening agent.

22. A printer cartridge comprising a sealant to prevent toner leakage wherein the sealant comprises a synthetic hydrocarbon oil and a thickener and the sealant is present as a coating on at least one of (a) the surface of each end of a developer roller or (b) the surface of each of a pair of end seals wherein each end seal bears against one end of a developer roller.

23. The printer cartridge of claim 22 wherein the sealant is present as a coating on both (a) the surface of each end of the developer roller and (b) the surface of each end seal.

24. The printer cartridge of claim 23 wherein the thickening agent is an inorganic thickening agent.

25. The printer cartridge of claim 23 wherein the thickening agent is an organic thickening agent.

26. A method to prevent toner leakage from a printer cartridge comprising applying a sealant to at least one of (a) the surface of each end of a developer roller or (b) the surface of each of a pair of end seals wherein each end seal bears against one end of the developer roller and wherein the sealant comprises an oil and a thickener wherein the oil is selected from the group consisting of a perhalogenated oil, a silicone oil and a synthetic hydrocarbon oil.

27. The method of claim 26 comprising applying a sealant to both (a) the surface of each end of the developer roller and (b) the surface of each end seal.

28. The method of claim 26 or 27 wherein the sealant comprises a perhalogenated oil and a thickener.

29. The method of claim 28 comprising applying the sealant to the surface of each end of the developer roller using a cotton swab, rotating the developer roller to expose a new surface of the developer roller end, inspecting the new surface, and repeating the steps of applying sealant, rotating the developer roller and inspecting the new surface until the ends of the developer roller are coated with a continuous layer of sealant.

30. The method of claim 28 further comprising applying an additional amount of sealant to the surface of the developer roller until a reservoir of sealant is in contact with the surface of a developer roller sealing blade in the areas where the sealing blade overlaps the end seals.

31. A method to remanufacture a printer cartridge comprising (a) filling a toner supply with toner; and (b) applying a sealant to at least one of (1) the surface of each end of a developer roller or (2) the surface of each of a pair of end seals wherein each end seal bears against one end of a developer roller, and wherein the sealant comprises an oil and a thickener wherein the oil is selected from the group consisting of a perhalogenated oil, a silicone oil and a synthetic hydrocarbon oil.

32. The method of claim 31 wherein the sealant comprises a perhalogenated oil and a thickener.

33. The method of claim 32 comprising, prior to filling a toner supply with toner, the steps of: disassembling the printer cartridge to expose the end seals; cleaning the end seals; applying sealant to the end seals; and
reassembling the printer cartridge.

34. The method of claim 33 further comprising, after filling a toner supply with toner, the step of applying a sealant to the ends of the developer roller.

35. The method of claim 33 wherein the thickener is an inorganic thickener.

36. The method of claim 33 wherein the thickener is an organic thickener.
